(19) United States
(12) Patent Application Publication
(10) Pub. No.: US 2010/0001078 A1
(43) Pub. Date: Jan. 7, 2010

(54) TRASPONDER UNIT

(75) Inventors: Manfred Rietzler, Marktoberdorf (DE); Wolfgang Schneider, Obersontheim (DE)

Correspondence Address: SCHWEGMAN, LUNDBERG & WOESSNER, P.A., P.O. BOX 2938, MINNEAPOLIS, MN, 55402, US

(73) Assignee: Smartrac IP B.V., Amsterdam (NL)

(21) Appl. No.: 12/312,559

(22) PCT Filed: Oct. 25, 2007
(86) PCT No.: PCT/EP2007/009254

§ 371 Date: May 15, 2009

(30) Foreign Application Priority Data
Nov. 16, 2006 (DE) 10 2006 054 449.8

(51) Int. Cl. G06K 19/077

(52) U.S. Cl. 235/492

(57) ABSTRACT

The invention relates to a transponder unit (10), in particular for transponder cards, identification documents or suchlike, having at least one chip (15) and at least one antenna (11), wherein the antenna is formed from a metal conductor which is arranged on an antenna substrate (14) and is permanently connected to the latter, and wherein said conductor is provided with a structure device which is integrally connected to the conductor and is intended to form a composite conductor (12) such that the composite conductor has a higher tensile stress or a higher elongation break than the conductor.

The invention relates to a transponder unit, in particular for transponder cards, identification documents or suchlike, having at least one chip and at least one antenna, wherein the antenna is formed from a metal conductor which is arranged on an antenna substrate and is permanently connected to the latter.

Transponder units of the type mentioned at the beginning are well known and are regularly used in the manufacture of transponder cards, identification documents, charge cards or similar applications. In the transponder units known from the prior art, the antenna substrate serves as the support for the antenna and the chip contacted with the antenna, wherein the antenna and the chip are permanently connected with the substrate. The antenna substantially consists of pure copper and is formed by galvanic processes as conductor path or as wire in wire laying technology on the antenna substrate. If a copper wire is used, this wire can be coated with baked enamel which enables a good connection with the antenna substrate as well as a laying of the wire crosswise. Transponder units formed in such a manner are generally accommodated between a plurality of cover layers and laminated with the latter to form a transponder card. Identification documents with transponder units produced in the wire laying technology are known, amongst others, from DE 103 38 444 A1 and DE 10 2004 004 469 A1.

Identification documents and charge cards such as, for example, identification cards, passports, bank cards and credit cards are regularly carried by people and apart from their intended use, are permanently kept in wallets, billfolds or suchlike. Since wallets and billfolds due to their intrinsic value are preferably worn in garments on the body, for example, in a back pocket, the transponder cards kept therein are exposed to high and variable bending and torsional stresses due to continuous body movements, for example, when sitting. Since the layer structure of the card usually consists of plastic materials or plastic composite materials with comparatively good elasticity, a metal antenna arranged between the layers upon a bending of the transponder card is exposed to high tensile, compressive and flexural stresses depending on the position of the antenna to the bending line of the transponder card. Such stresses can lead to a break of the antenna in addition to a mechanical stress of the transponder card during the course of its intended use.

The object of the present invention is therefore to provide a transponder unit in which the break behavior of an antenna influenced by a bending and torsional stress of a transponder card is improved compared to the antennas known from the prior art. This object is achieved by a transponder unit with the features of claims 1 or 2.

The transponder according to the invention comprises according to a first solution a conductor provided with a structure device which is integrally connected to the conductor and is intended to form a composite conductor such that the composite conductor has a higher tensile stress than the conductor. The transponder unit can thus withstand in an advantageous manner flexural and torsional stresses through the antenna connected with the transponder unit. The breaking strength of the antenna is substantially improved by the higher supportable mechanical tensile stress of the composite conductor compared to an antenna with a conventional conductor.

According to a second solution, the transponder unit according to the invention comprises a conductor which is provided with a structure device which is integrally connected to the conductor and is intended to form a composite conductor such that the composite conductor shows a higher mechanical elongation at break than the conductor. A higher elastic, respectively, plastic deformation capacity results from the higher mechanical elongation at break with a tensile stress of the composite conductor. Such a composite conductor is relatively more elastic than a conventional conductor so that a transponder unit with an antenna which is formed from such a composite conductor is comparatively more flexible than a transponder unit with a conventional antenna. Thereby a comparatively lower resistance withstands a deformation of the transponder unit due to bending and torsional stresses so that the break of an antenna can be avoided in an advantageous manner.

It proves to be especially advantageous if the structure device of the conductor substantially consists of at least one metal material. Thus, a good integral connection can be simply formed between the metal conductor and the structure device, respectively, a plurality of metal materials which can form the structure device.

In a further embodiment, the structure device of the conductor can be at least an alloy component of the conductor. Thus, the formation of a composite conductor is possible in a simple manner with the structure device in a particle composite, respectively, out of an alloyed material. The material used for the alloying of the conductor can comprise metal or non-metal, respectively, different material components.

If the structure device of the conductor is at least a cover layer of the conductor, a composite conductor can be formed simply through fusion or galvanic application of a metal material on the conductor. The coating layer can also be formed from a non-metal material or composite material which surrounds the conductor and influences its mechanical properties in the desired manner.

It proves to be especially advantageous if the cover layer of the conductor is formed by diffusion. If the conductor is coated with a metal material, a cover layer can be formed by annealing, for example, which is characterized by a continuous or a regular transition in parts of the cover layer between the metal material and the material of the conductor.

The advantageous properties of a rope, respectively, a litz wire in respect of bending and tensile strength are useful for a conductor when the structure device of the conductor is formed from a litz wire or a from a rope. The rope, respectively, the litz wire can be formed as the core of the conductor, wherein the conductor is fused on the rope, respectively the litz wire. In further embodiments the rope, respectively, the litz wire can completely or partially surround the conductor.

A simple formation of a composite conductor independently of an antenna substrate is possible when the conductor is formed as wire. A composite conductor can be formed, therefore, before a connection with the antenna substrate, whereby the manufacture of the composite conductor is substantially simplified.

In an embodiment, the conductor can be formed as a coating of an antenna substrate formed by etching. Thus, a formation of the composite conductor is simply possible with the simultaneous connection with the antenna substrate without having to make a connection between the antenna substrate and the composite conductor after the formation of the composite conductor.

In the following, preferred embodiments of the invention are described in more detail with reference to the attached drawings.

In the figures:

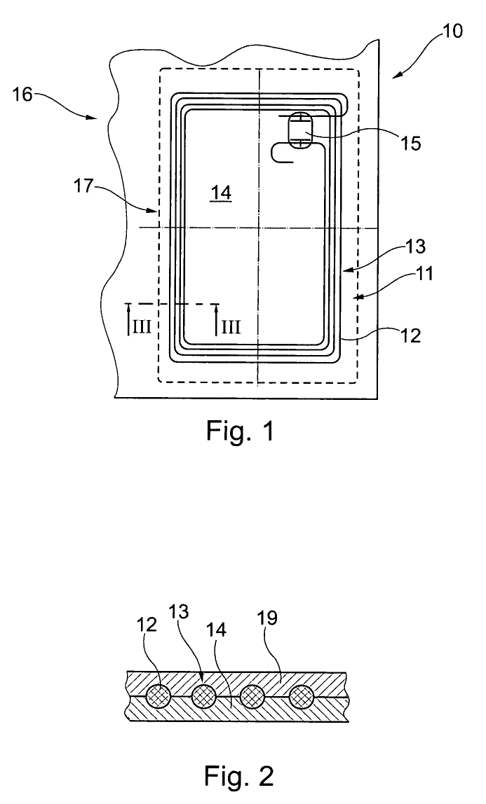

FIG. 1 shows a top view of a transponder unit;

FIG. 2 shows a sectional view of the transponder unit along a line II-II from FIG. 1 with a cover layer;

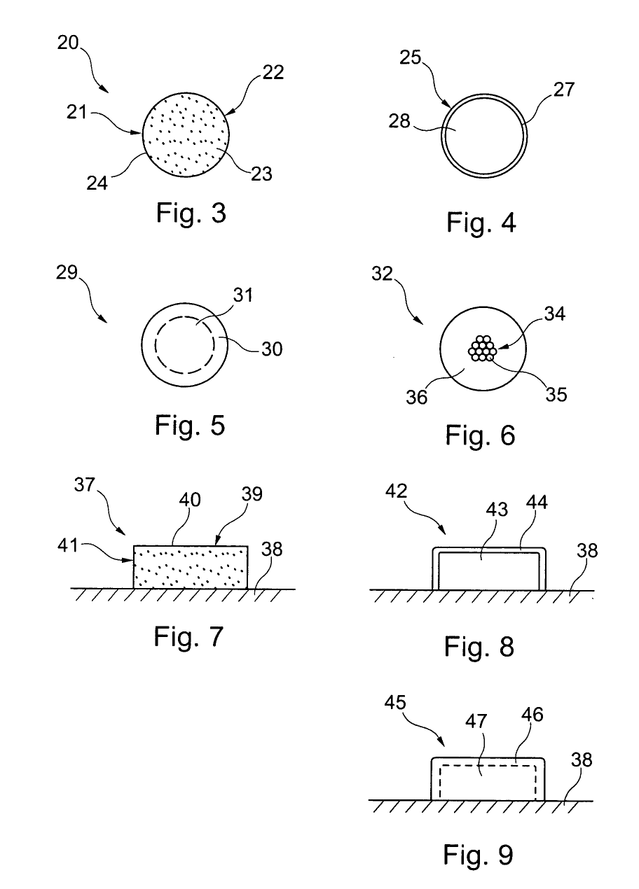

FIG. 3: shows a first embodiment in cross-section of a composite conductor;

FIG. 4: shows a second embodiment in cross-section of a composite conductor;

FIG. 5: shows a third embodiment in cross-section of a composite conductor;

FIG. 6: shows a fourth embodiment in cross-section of a composite conductor;

FIG. 7: shows a fifth embodiment in cross-section of a composite conductor;

FIG. 8: shows a sixth embodiment in cross-section of a composite conductor;

FIG. 9: shows a seventh embodiment in cross-section of a composite conductor.

FIG. 1 shows a transponder unit 10 with an antenna 11, which is formed from a composite conductor 12. The composite conductor 12 is laid in the wire laying method with a plurality of windings 13 on an antenna substrate 14 and is connected to the antenna substrate 14. Further, the composite conductor 12 is contacted with a chip 15, which is located on the antenna substrate 14. In the illustration shown here the antenna substrate 14 is in the form of a panel sheet 16 for manufacturing a plurality of transponder cards from which transponder cards with the contour 17 represented here as a dotted line are detached in a subsequent work step. A cover layer covering the transponder unit 10 is not shown in this view.

The principle structure of a transponder card not shown in more detail is obvious from an overall view of FIG. 1 and FIG. 2. FIG. 2 shows a cross-section along a line II-II from FIG. 1 with windings 13 of the composite conductor 12 on the antenna substrate 14. The antenna substrate 14 and the windings 13 are permanently connected to a cover layer 19 to form a transponder card with the transponder unit 10, for example, by lamination. Other cover layers not shown here can be applied to the antenna substrate 14 and the cover layer 19 to form a transponder card.

FIG. 3 shows in a first embodiment a composite conductor 20 in cross-section. The composite conductor 20 is formed with a circular cross-section 21 and comprises a structure device 22 consisting of particles 23 of an alloy material in an integrally connected particle composite with the metal conductor 24. Depending on the choice of the alloy material, the composite conductor 20, for example, can show a higher mechanical elongation at break or a higher mechanical tensile stress compared to the conductor 24.

FIG. 4 shows a composite conductor 25 in which a structure device is formed as a cover layer 27. The cover layer 27 is formed from a metal material, for example, and is applied to a conductor 28 by galvanic process or fusion to form the composite conductor 25.

Starting from the composite conductor 25 shown in FIG. 4, a composite conductor 29 as illustrated in FIG. 5 can be formed. A cover layer 30 is formed by diffusion of the cover layer 27 into the conductor 28 so that the material of the cover layer 27 is changed over to an alloy forming the cover layer 30 with the material of the conductor 28. The cover layer 30 thereby comprises a concentration of alloy components which diminishes up to a conductor 31 or is a uniform concentration in parts of the cover layer.

FIG. 6 shows a composite conductor 32 with a structure device, which is formed as a rope 34. The rope 34 is formed from a plurality of wires 35. The wires 35 can, for example, consist of high tensile steel and the conductor 36 surrounding the rope 34 can consist of copper.

FIG. 7 shows a composite conductor 37 which is formed by etching on an antenna substrate 38. A structure device 39 of the composite conductor 37 is formed in the form of a particle composite, respectively, of an alloy component of a conductor 40 analogous to the description of FIG. 3. In contrast to FIG. 3, the composite conductor 37 is formed with a rectangular cross-section 41 as a conductor path.

A composite conductor 42 on the antenna substrate 38 with a cover layer 44 partially surrounding a conductor 43 is shown in FIG. 8. The cover layer 44 does not completely surround the conductor 43 since the cover layer 44 was applied on the conductor 43 by a galvanic method or fusing only after formation of the conductor 43 on the antenna substrate 38.

A composite conductor 45 with a cover layer 46 formed in a diffusion method is shown in FIG. 9. The formation of the cover layer 46 takes place analogous to the formation of the cover layer 30 described in FIG. 5 using the conductor 43 with the cover layer 44. The cover layer 46 does not completely surround a conductor 47 therefore since a lateral surface of the conductor 47 is covered by the antenna substrate 38.

Not illustrated here is a composite conductor on an antenna substrate with a cover layer completely surrounding the composite conductor. To form this composite conductor a cover layer material is first applied to the antenna substrate, then a conductor material and finally the cover layer material then surrounding the conductor. Subsequently, a diffusion process for forming an alloyed cover layer can be carried out.

1. A transponder unit comprising:
a transponder unit for transponder cards, identification documents or suchlike having at least one chip and at least one antenna, wherein said antenna is formed from a metal conductor, which is arranged on an antenna substrate and is permanently connected to the latter,
wherein said conductor is provided with a structure device which is integrally connected to said conductor and is operable to form a composite conductor such that said composite conductor has a higher tensile stress than said conductor.

2. The transponder unit comprising:
a transponder unit for transponder cards, identification documents or suchlike, having at least one chip and at least one antenna, wherein said antenna is formed from a metal conductor which is arranged on an antenna substrate and is integrally connected to the latter,
wherein said conductor is provided with a structure device which is integrally connected to said conductor and is operable to form a composite conductor such that said composite conductor has a higher elongation at break than the conductor.

3. The transponder unit according to claim 1, wherein
said structure device of said conductor substantially consists of at least one metal material.

4. The transponder unit according to claim 1, wherein
said structure device of said conductor is at least an alloy component of said conductor.

5. The transponder unit according to claim 1, wherein
said structure device of said conductor is at least a cover layer of said conductor.

6. The transponder unit according to claim 5,
wherein said cover layer of said conductor is formed by diffusion.

7. The transponder unit according to claim 1, wherein
said structure device of said conductor is formed from a litz wire or a rope.

8. The transponder unit according to claim 1, wherein
said conductor is formed as wire.

9. The transponder unit according to claim 1, wherein
said conductor is formed by etching as a coating of an antenna substrate.

10. The transponder unit according to claim 2, wherein said structure device of said conductor substantially consists of at least one metal material.

11. The transponder unit according to claim 2, wherein said structure device of said conductor is at least an alloy component of said conductor.

12. The transponder unit according to claim 2, wherein said structure device of said conductor is at least a cover layer of said conductor.

13. The transponder unit according to claim 12, wherein said cover layer of said conductor is formed by diffusion.

14. The transponder unit according to claim 2, wherein said structure device of said conductor is formed from a litz wire or a rope.

15. The transponder unit according to claim 2, wherein said conductor is formed as wire.

16. The transponder unit according to claim 2, wherein said conductor is formed by etching as a coating of an antenna substrate.
